(19) United States
(12) Patent Application Publication
(10) Pub. No.: US 2018/0257201 A1
(43) Pub. Date: Sep. 13, 2018

(54) FIXTURING COLLET ARRANGEMENTS AND FABRICATION METHODS

(71) Applicant: Swagelok Company, Solon, OH (US)

(72) Inventors: Roland Zellweger, Unterentfelden (CH); Peter Sennrich, Siebnen (CH); Bryan S. Reiger, Willowick, OH (US); Robert Bianco, Columbia Station, OH (US); Peter M. Oyster, Ravenna, OH (US); Jeremy Elek, Chagrin Falls, OH (US)

(21) Appl. No.: 15/910,180

(22) Filed: Mar. 2, 2018

Related U.S. Application Data
(60) Provisional application No. 62/466,763, filed on Mar. 3, 2017.

(51) Int. Cl. B25B 5/14

(52) U.S. Cl. CPC B25B 5/147; B33Y 10/00

(57) ABSTRACT

A collet member for fixturing a workpiece includes a monolithic collet body having a clamping block engaging outer wall portion, a workpiece engaging inner wall portion, a plurality of rigid, radially extending members extending between the outer wall and the inner wall to define a plurality of cavities, and a first radial wall on a first axial side of the collet body, defining a first closed end of the plurality of cavities.

### CROSS-REFERENCE TO RELATED APPLICATION

This application claims priority to and all benefit of U.S. Provisional Patent Application Ser. No. 62/466,763, filed on Mar. 3, 2017, for WELD COLLET, the entire disclosure of which is fully incorporated herein by reference.

### BACKGROUND

The use of rigid collets for holding tubing and other workpieces during welding operations has often been preferred over split or adjustable collets, due to the ability of the rigid collets to minimize misalignment between the workpieces being welded (e.g., due to thermal stresses). Referring to FIG. 1, a conventional rigid collet (shown, for example, in U.S. Pat. No. 4,868,367, the entire disclosure of which is incorporated herein by reference) includes a pair of solid, semi-cylindrical collet members 48, 50 retained in opposed clamp halves or clamping blocks 22, 24 of a clamp assembly 10. As shown, the collet elements define a cylindrical interior clamping surface 56 for securely positioning and retaining a cylindrical workpiece (e.g. a tube). The extended cylindrical clamping surface and solid collet construction, while providing for rigid, secure colleting of the workpieces, may contribute to increased heat transfer away from the workpieces, particularly for workpiece materials having high thermal conductivity, such as copper.

### SUMMARY

According to an aspect of the present application, a collet member for fixturing a workpiece may be configured to reduce heat transfer away from the clamped workpiece, by modifying a portion of the collet to provide one or more of: a reduced collet mass, a reduced workpiece contact surface, a workpiece engaging material having a reduced thermal conductivity, and a workpiece engaging material having an increased porosity.

According to another aspect of the present application, a collet member for fixturing a workpiece may be produced using additive manufacturing techniques (e.g., 3D printing) to facilitate fabrication of more complex collet geometries, including, for example, collets having portions configured for reduced collet mass and/or reduced workpiece contact surface. In other exemplary embodiments, additive manufacturing techniques may be used to fabricate collets having clamping features configured to facilitate fixturing of non-standard workpiece shapes (e.g., non-cylindrical shapes, fittings having flanged or hex-shaped ends). In still other exemplary embodiments, additive manufacturing techniques may be used to fabricate rigid collets having varying material properties (e.g., thermal conductivity) across the diameter of the collet.

Accordingly, in an exemplary embodiment, a collet member for fixturing a workpiece includes a monolithic collet body having a clamping block engaging outer portion with a first thermal conductivity, and a workpiece engaging inner portion with a second thermal conductivity less than the first thermal conductivity.

In another exemplary embodiment, a method of fabricating a collet member for fixturing a workpiece includes, using an additive manufacturing process, forming a monolithic collet body including a clamping block engaging outer portion having a first material property, and a workpiece engaging inner portion having a second material property different from the first material property.

In another exemplary embodiment, a collet member for fixturing a workpiece includes a monolithic collet body having a clamping block engaging outer wall portion, a workpiece engaging inner wall portion, a plurality of rigid, radially extending members extending between the outer wall and the inner wall to define a plurality of cavities, and a first radial wall on a first axial side of the collet body, defining a first closed end of the plurality of cavities.

In another exemplary embodiment, a method of fabricating a collet member for fixturing a workpiece includes, using an additive manufacturing process, forming a monolithic collet body including a clamping block engaging outer portion and a workpiece engaging inner portion including a workpiece engaging surface configured to engage a non-cylindrical portion of a workpiece.

### BRIEF DESCRIPTION OF THE DRAWINGS

Further advantages and benefits will become apparent to those skilled in the art after considering the following description and appended claims in conjunction with the accompanying drawings, in which:

FIG. 1 is a perspective view of a fixture for holding a workpiece;

FIG. 2 is a perspective view of a collet for a workpiece holding fixture, in accordance with an exemplary embodiment of the present application;

FIG. 3 is a perspective view of another collet for a workpiece holding fixture, in accordance with another exemplary embodiment of the present application;

FIG. 4 is a perspective view of another collet for a workpiece holding fixture, in accordance with another exemplary embodiment of the present application;

FIG. 5 is a perspective view of another collet for a workpiece holding fixture, in accordance with another exemplary embodiment of the present application;

FIG. 6 is a perspective view of another collet for a workpiece holding fixture, in accordance with another exemplary embodiment of the present application;

FIG. 7 is a perspective view of another collet for a workpiece holding fixture, in accordance with another exemplary embodiment of the present application;

FIG. 8 is a perspective view of another collet for a workpiece holding fixture, in accordance with another exemplary embodiment of the present application;

FIG. 9 is a perspective view of another collet for a workpiece holding fixture, in accordance with another exemplary embodiment of the present application; and

FIG. 10 is a perspective view of another collet for a workpiece holding fixture, in accordance with another exemplary embodiment of the present application.

### DETAILED DESCRIPTION

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

The Detailed Description merely describes exemplary embodiments and is not intended to limit the scope of the claims in any way. Indeed, the invention as claimed is broader than and unlimited by the exemplary embodiments, and the terms used in the claims have their full ordinary meaning. For example, while specific exemplary embodiments in the present application describe collets for use with weld fixtures in orbital welding systems, one of more of the features described herein may additionally or alternatively be applied to other types of welding systems, or for use in other types of fixturing applications. Additionally, while the geometries and arrangements of many of the collets described herein are such that their production is facilitated by additive manufacturing, other manufacturing methods may be utilized to fabricate collets having one or more of the features described herein, such as, for example, stacked plate assembly, machining, welding, brazing, and casting (e.g., investment casting, sand casting, lost wax casting).

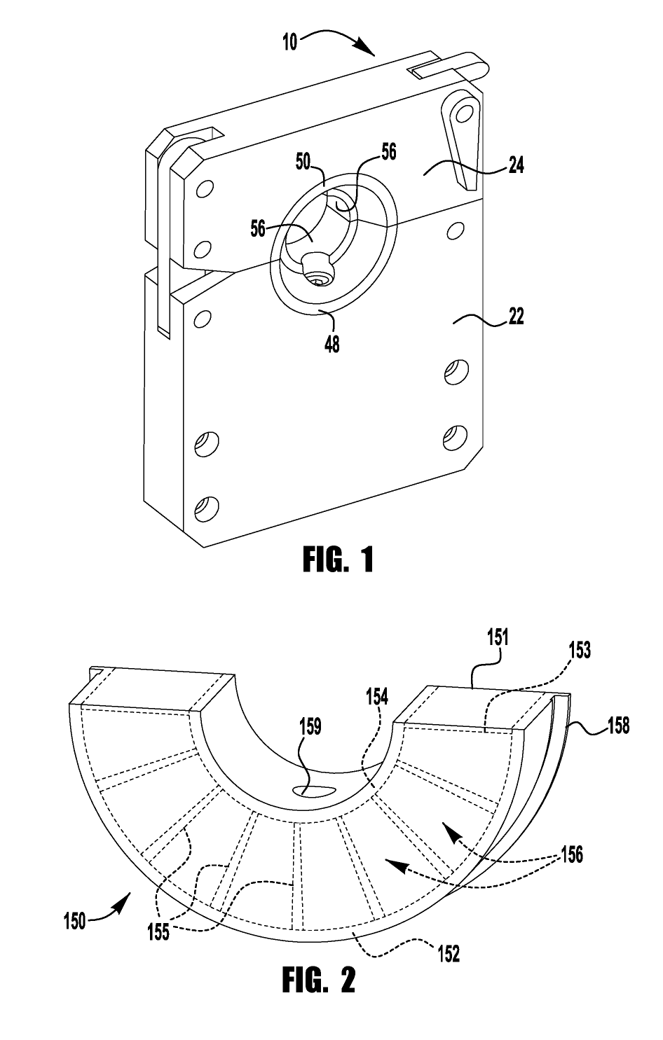

FIG. 2 illustrates an exemplary collet member 150 for use with a weld fixture (e.g., the exemplary fixture assembly 10 of FIG. 1). While the exemplary collet member 150 has a semi-cylindrical body 151, other collet body shapes may alternatively be utilized (e.g., rectangular, hex-shaped). The collet body 151 includes a clamping block engaging outer portion (shown schematically at 152), a workpiece engaging inner portion (shown schematically at 154), and an intermediate portion (shown schematically at 153) extending radially between the outer portion 152 and the inner portion 154. The exemplary collet member 150 also includes an outer radial flange 158 for abutting the exterior side (i.e. opposite the weld side) of the clamping block to axially position the collet member 150, and a radially extending fastener bore 159 for receiving a fastener for affixing the collet member 150 to the clamping block.

According to an aspect of the present application, a collet member for a weld fixture may be configured to provide for reducing heat transfer away from a fixtured workpiece during welding. Referring to FIG. 2, in an exemplary embodiment, the inner portion 154 of the collet body 151 may have a reduced thermal conductivity compared to the outer portion 152 of the collet body, to reduce heat transfer from the workpiece. In one such embodiment, the inner portion 154 of the collet body 151 may be provided in a different material than the outer portion 152, having a lower thermal conductivity. For example, the inner portion 154 of the collet body 151 may comprise titanium alloys such as Ti-6Al-4V, zirconium and its alloys, nickel-base alloys such as Hastelloy C and X, Inconel alloy 625 and 718, and Monel alloy 400 and K-500, cobalt-base alloys such as Haynes 25 and CoCr derivatives, or any suitable material having a relatively low thermal conductivity (e.g., less than 20 W/mK) and the outer portion 152 may comprise stainless steel, aluminum and its alloys, copper and its alloys such as brass and bronze, or any suitable material having a higher thermal conductivity (e.g., greater than 20 W/mK). Material compatibility may be a consideration when selecting material pairs. The use of different materials may, for example, provide for cost efficiencies, and/or desirable variations in density, heat capacity, and/or corrosion behavior/resistance. In another exemplary embodiment, the inner portion 154 of the collet body 151 may have a greater material porosity (e.g., void volume fraction greater than about 15%) than the outer portion 152, with the greater porosity providing for a reduced thermal conductivity.

The workpiece engaging inner portion material of the collet body may additionally or alternatively be configured to provide other desirable properties, including, for example, increased elasticity, corrosion behavior/resistance, and/or density.

While variations in materials or material properties in the collet member may be accomplished by mechanically fixing outer radial and inner radial components together to form the collet body, according to another aspect of the present application, additive manufacturing may be utilized to produce a monolithic collet body having the desired properties across the radial thickness of the collet body. Examples of additive manufacturing techniques that may be utilized include, for example: laser powder bed fusion (direct metal laser sintering or “DMLS,” selective laser sintering/melting or “SLS/SLM,” or layered additive manufacturing or “LAM”), electron beam powder bed fusion (electron beam melting or “EBM”), ultrasonic additive manufacturing (“UAM”), or direct energy deposition (laser powder deposition or “LPD,” laser wire deposition or “LWD,” laser engineered net-shaping or “LENS,” electron beam wire deposition). Providing the collet body as a single, monolithic component may eliminate assembly costs, reduce component wear, reduce adverse effects from heat cycling, improve corrosion behavior (galvanic effects, crevice, stress corrosion cracking), and reduce lead time to manufacture.

According to another aspect of the present application, heat transfer away from a fixtured workpiece may be reduced by reducing the material mass of the collet member, and/or providing cavities or air gaps in the collet member that impede thermal conduction. In one such embodiment, the intermediate portion 153 of the collet body 151 may include a plurality of rigid, radially extending members 155 (e.g., ribs, pins, fins, blades, etc.) extending between the outer portion 152 and the inner portion 154 to define a plurality of cavities 156.

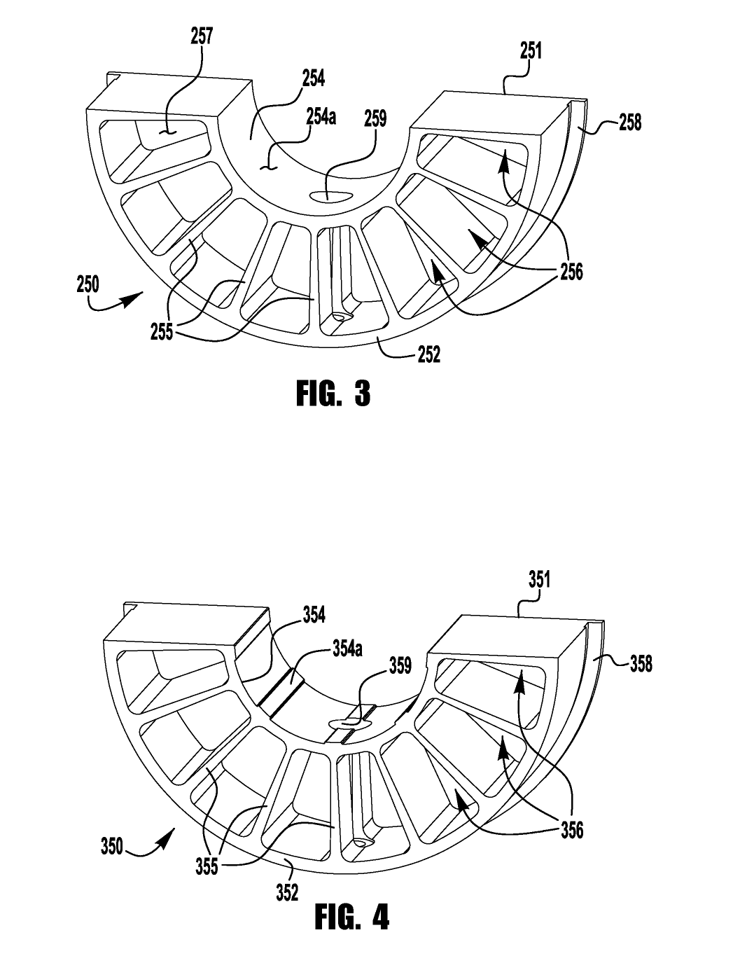

FIG. 3 illustrates an exemplary collet member 250 including a collet body 251 having an outer semi-cylindrical wall portion 252 for engagement with a clamping block, an inner semi-cylindrical wall portion 254 for engaging a workpiece (e.g., a tube end or other cylindrical workpiece), and a plurality of ribs 255 extending from the outer wall portion 252 to the inner wall portion 254 to define a plurality of cavities 256. While the cavities may extend across the entire axial length of the collet member 250, in the illustrated embodiment, a radial wall 257 is provided on a first axial side of the collet body 251, to define a closed end of the cavities 256. When used, for example, in an orbital weld fixture, this closed condition may be desirable for containment of the weld gases during the welding operation. In the illustrated embodiment, the radial wall 257 is disposed on the exterior side (i.e., opposite the weld side) of the collet member 250, in axial alignment with the outer flange 258. Additionally or alternatively, the radial wall 257 may provide further rigid reinforcement for the collet member 250 during clamping. In other embodiments (not shown), the radial wall may be disposed on the interior side (i.e., the weld side) of the collet member, for example, to reduce the volume to be filled by the weld gas. In still other embodiments, radial walls may be provided on both axial sides of the collet body, for example, to provide additional reinforcement, such that the cavities are fully enclosed between the first and second radial walls. Fabrication of an enclosed cavity collet member may be facilitated by the use of additive manufacturing techniques, such as, for example, the techniques described in greater detail above.

While the inner wall portion 254 of the collet body may provide a semi-cylindrical workpiece engaging surface 254a, as shown in FIG. 3, in other embodiments, the inner wall portion may include one or more radially inward extending protrusions sized and positioned to reduce the contact surface between the collet member and the workpiece. FIG. 4 illustrates an exemplary collet member 350 having a collet body 351 with an inner wall portion 354 having a plurality of radially inward extending protrusions 354a defining a reduced workpiece engaging surface, for example, to reduce heat transfer between the workpiece and the collet member 350. These protrusions may, but need not, comprise a different material or material property than the intermediate and/or outer portions of the collet body 351, for example to provide a reduced thermal conductivity (as described above), increased elasticity, improved corrosion behavior, and/or allowance for variations in dimension or shape of the workpiece engaging protrusions. As shown, the protrusions 354a may extend the entire axial length of the collet member 350. Alternatively (not shown), the protrusions may terminate axially inward of the axial ends of the collet body.

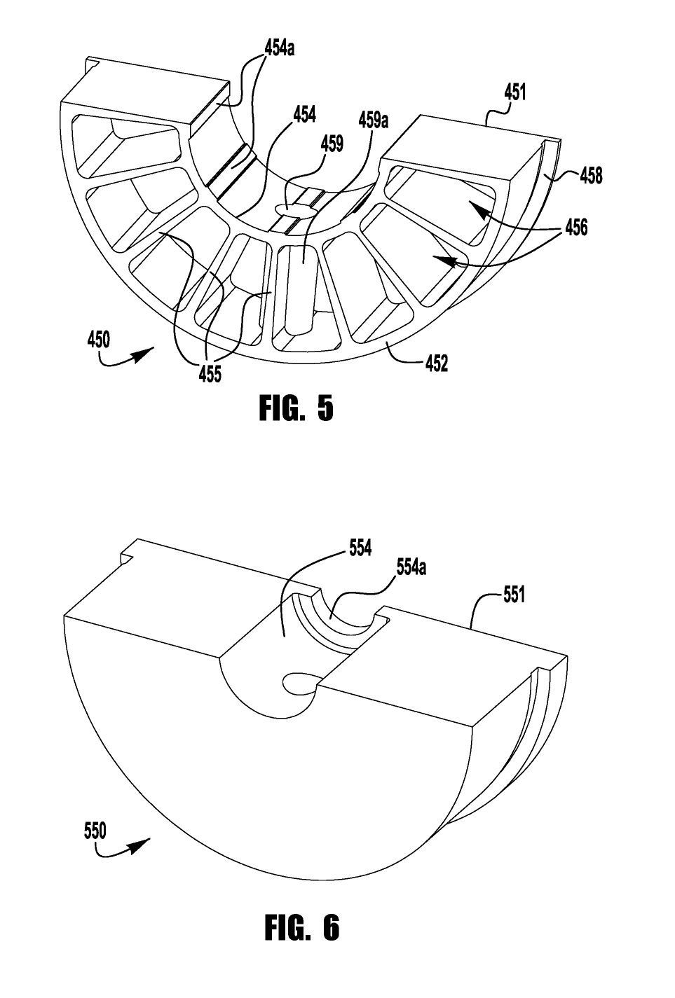

In the collet members 250, 350 of FIGS. 3 and 4, the radially extending fastener bore 259, 359 intersects one of the ribs 255, 355, for example, to facilitate positioning and alignment of the installed fastener (not shown) when affixing the collet member 250, 350 to the clamping block. In another embodiment, a hollow fastener boss may be formed between the inner wall portion and the outer wall portion of a collet member, for example, to retain and guide the fastener when affixing the collet member to a clamping block. This fastener boss may intersect one of the radially extending members, for example, for further reinforcement. FIG. 5 illustrates an exemplary collet member 450 having a collet body 451 with a hollow fastener boss 459a defining the fastener bore 459 and extending between the outer and inner wall portions 452, 454 and intersecting one of the radially extending ribs 455.

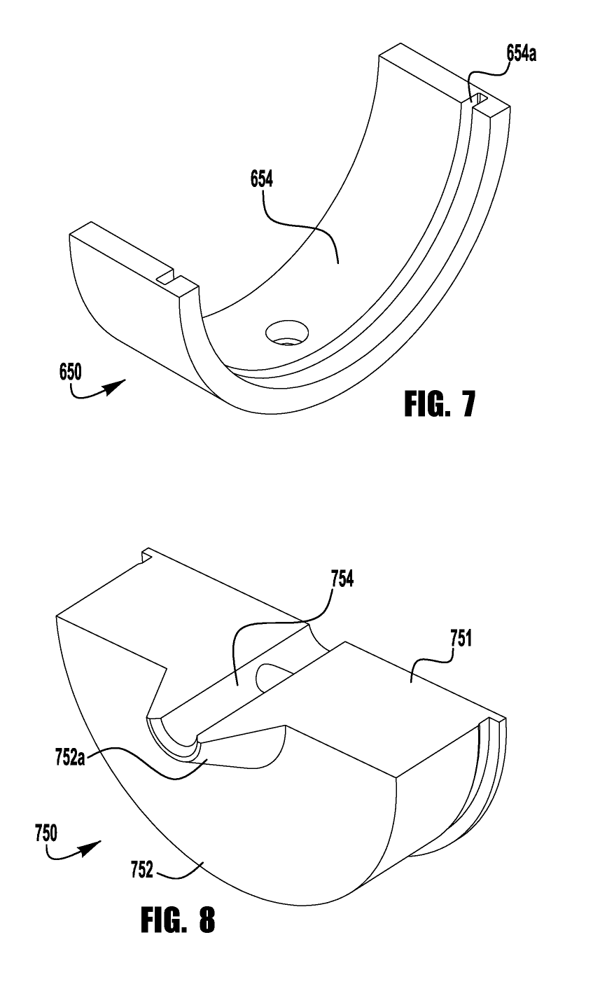

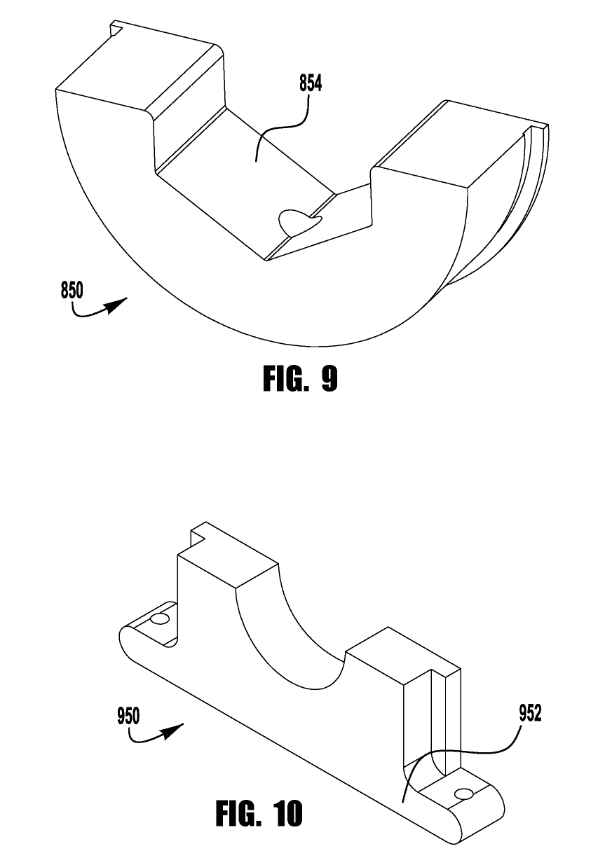

Additive manufacturing techniques for fabricating collet members, as described herein, may additionally be used to fabricate special, customer specific colleting configurations, for example, without requiring expensive and time-consuming casting processes. These techniques may be used, for example, to produce collet members having alternative geometries. For example, FIGS. 6 and 7 each illustrate an exemplary collet member 550, 650 having a modified inner diameter or inner workpiece engaging portion 554, 654, for example, to provide clearance for a non-cylindrical outer portion of a workpiece (e.g., a flange or other radial extension). In the exemplary embodiment of FIG. 6, a radially extending lip 554a is provided to engage the workpiece, providing radial clearance between the lip and the surface of the inner wall portion 554. In the exemplary embodiment of FIG. 7, a radially recessed groove 654a in the inner wall portion 654 provides clearance for a radially extending portion of the workpiece. As another example, FIG. 8 illustrates an exemplary collet member 650 having a modified outer wall portion 752 (e.g., with cone shaped extension 752a), for example, to axially extend the collet body 751 to provide an axially extended inner wall portion 754 without extending the clamping block engaging portion of the outer wall portion. As another example, FIG. 9 illustrates a collet member 850 having an inner wall portion 854 defining a non-cylindrical workpiece engaging surface (as shown, a hex-shaped surface, but other shapes and contours may be provided). FIG. 10 illustrates a different type of collet member 950, having a non-cylindrical outer wall portion 952.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A collet member for a colleting fixture, the collet member comprising:
a monolithic collet body including a clamping block engaging outer portion having a first thermal conductivity, and a workpiece engaging inner portion having a second thermal conductivity less than the first thermal conductivity.

2. The collet member of claim 1, wherein the outer portion has a first porosity and the inner portion has a second porosity greater than the first porosity.

3. The collet member of claim 1, wherein the outer portion comprises a first material and the inner portion comprises a second material different than the first material.

4. The collet member of claim 1, wherein the outer portion comprises at least one of stainless steel, aluminum and its alloys, and copper and its alloys, and the inner portion comprises at least one of titanium alloys, nickel-base alloys, Hastelloy C and X, Monel alloy 400 and K-500, and cobalt-base alloys.

5. The collet member of claim 1, wherein the outer portion comprises a semi-cylindrical outer wall.

6. The collet member of claim 1, wherein the inner portion comprises a semi-cylindrical inner wall defining a semi-cylindrical workpiece engaging surface.

7. The collet member of claim 1, wherein the inner portion comprises a plurality of radially inward extending protrusions defining a plurality of discrete workpiece engaging surfaces.

8. The collet member of claim 1, wherein the outer portion comprises an outer wall and the inner portion comprises an inner wall, wherein the collet body further comprises a plurality of rigid, radially extending members extending between the outer wall and the inner wall to define a plurality of cavities.

9. The collet member of claim 8, wherein the plurality of cavities is bounded on a first axial side by a first radial wall.

10. The collet member of claim 9, wherein the plurality of cavities is bounded on a second axial side by a second radial wall, such that the plurality of cavities is fully enclosed.

11. The collet member of claim 8, further comprising a hollow fastener boss extending from the outer wall to the inner wall.

12. The collet member of claim 11, wherein one of the plurality of radially extending members is intersected by the hollow faster boss.

13. A method of fabricating a collet member for a colleting fixture, the method comprising:
using an additive manufacturing process, forming a monolithic collet body including a clamping block engaging outer portion having a first material property, and a workpiece engaging inner portion having a second material property different from the first material property.

14. The method of claim 13, wherein the first material property comprises a first thermal conductivity and the second material property comprises a second thermal conductivity less than the first thermal conductivity.

15. The method of claim 14, wherein forming the monolithic collet body comprises forming the outer portion from a first material having the first thermal conductivity and forming the inner portion from a second material having the second thermal conductivity.

16. (canceled)

17. The method of claim 14, wherein forming the monolithic collet body comprises forming the outer portion with a first porosity and forming the inner portion with a second porosity greater than the first porosity for a reduced thermal conductivity.

18. The method of claim 13, wherein forming the monolithic collet body comprises forming the outer portion with a first elasticity and forming the inner portion with a second elasticity greater than the first elasticity

19.-24. (canceled)

25. A collet member for a colleting fixture, the collet member comprising:
a monolithic collet body including a clamping block engaging outer wall portion, a workpiece engaging inner wall portion, a plurality of rigid, radially extending members extending between the outer wall and the inner wall to define a plurality of cavities, and a first radial wall on a first axial side of the collet body, defining a first closed end of the plurality of cavities.

26.-28. (canceled)

29. The collet member of claim 25, wherein the inner wall portion includes a plurality of radially inward extending protrusions defining a plurality of discrete workpiece engaging surfaces.

30. The collet member of claim 25, wherein the collet body further comprises a second radial wall on a second axial side of the collet body, defining a second closed end of the plurality of cavities, such that the plurality of cavities is fully enclosed.

31.-34. (canceled)
